(19) United States
(12) Patent Application Publication
(10) Pub. No.: US 2015/0065172 A1
(43) Pub. Date: Mar. 5, 2015

(54) GEOGRAPHIC AREA AND CATEGORY SPECIFIC CONTENT SHARING BETWEEN MOBILE DEVICES

(71) Applicant: INTERNATIONAL BUSINESS MACHINES CORPORATION, Armonk, NY (US)

(72) Inventors: LYDIA M. DO, RALEIGH, NC (US); CHRISTOPHER J. HARDEE, RALEIGH, NC (US); ADRIAN X. RODRIGUEZ, DURHAM, NC (US); ERIC WOODS, DURHAM, NC (US)

(73) Assignee: INTERNATIONAL BUSINESS MACHINES CORPORATION, Armonk, NY (US)

(21) Appl. No.: 14/016,450

(22) Filed: Sep. 3, 2013

(51) Int. Cl. H04W 4/02; H04W 12/08

(52) U.S. Cl. CPC H04W 4/023; H04W 12/08
USPC 455/456.3

(57) ABSTRACT

A method, system, and/or computer program product automatically shares content between mobile devices. Permissible geographic areas for sharing digital content from a user's mobile device are received, where the digital content is from a user-approved category of digital content. A determination is made as to whether an authorized mobile receiving device is within a specific permitted geographic area from the permissible geographic areas. In response to determining that the authorized mobile receiving device is within the specific permitted geographic area, the digital content is automatically shared between the user's mobile device and the authorized mobile receiving device.

### BACKGROUND

The present disclosure relates to the field of mobile devices, and specifically to the use of mobile devices that are able to receive, store, retrieve, and share content. Still more particularly, the present disclosure relates to sharing content between mobile devices based on the geographic location of the mobile devices and the category of content that is shared between the mobile devices.

Mobile devices are defined as devices that have computing power and data storage abilities, as well as mobile communication abilities. Examples of such mobile devices include “smart phones”, laptop computers, tablet computers, etc., each of which have not only internal processors and memories, but also have Wi-Fi and/or other short-range protocolled communication transceivers for communicating and sending wireless communication messages/packets.

### SUMMARY

A method, system, and/or computer program product automatically shares content between mobile devices. Permissible geographic areas for sharing digital content from a user's mobile device are received, where the digital content is from a user-approved category of digital content. A determination is made as to whether an authorized mobile receiving device is within a specific permitted geographic area from the permissible geographic areas. In response to determining that the authorized mobile receiving device is within the specific permitted geographic area, the digital content is automatically shared between the user's mobile device and the authorized mobile receiving device.

### BRIEF DESCRIPTION OF THE SEVERAL VIEWS OF THE DRAWINGS

FIG. 1 depicts an exemplary system and network which may be used to implement the present invention;

FIG. 2 depicts an exemplary geographic map of various geographic regions that have been defined by a user according to the respective regions' authorization to receive content from a user's mobile device;

FIG. 3 illustrates an exemplary table of information describing the map in FIG. 2 and/or what type of content is authorized to be shared within each of the geographic regions shown in the map in FIG. 2; and

FIG. 4 is a high level flow chart of one or more exemplary steps taken by one or more processors to auto-share content between mobile devices based on their location and the type of content.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

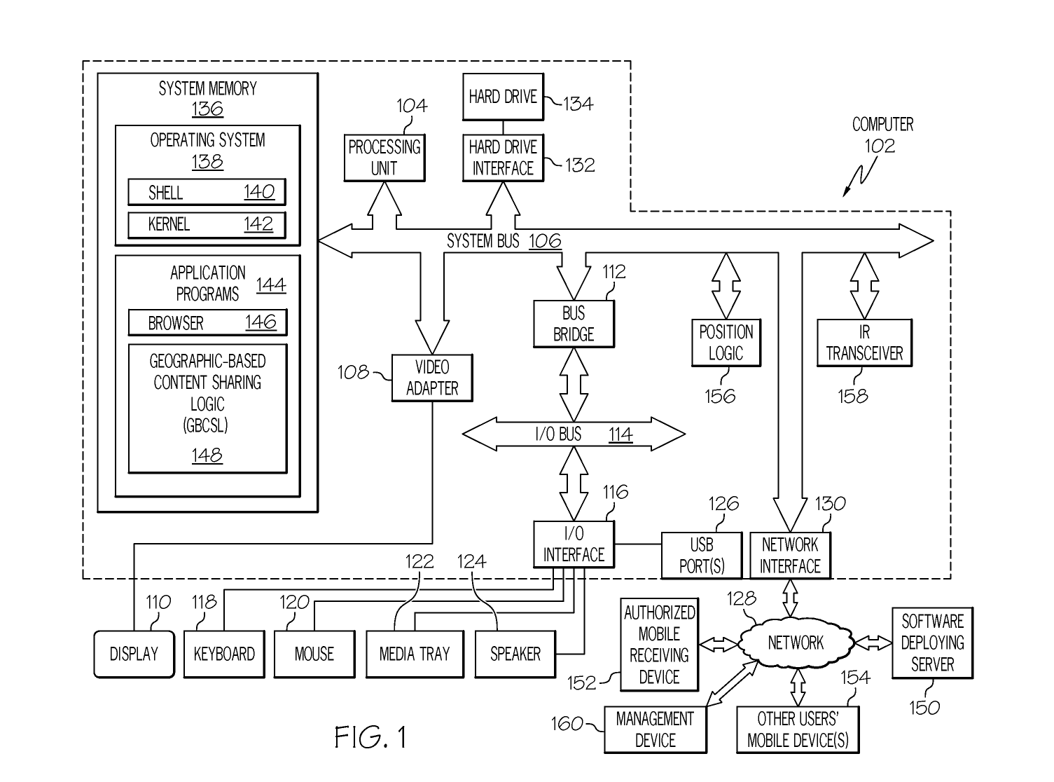

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150 and/or authorized mobile receiving device 152 and/or other users' mobile device(s) 154 and/or management device 160. Note that in one embodiment, computer 102, and/or authorized mobile receiving device 152 and/or other user's mobile device(s) 154, are mobile devices such as “smart” phones, personal digital assistants (PDAs), laptop computers, tablet computers, etc.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a speaker 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or authorized mobile receiving device 152 and/or other users' mobile device(s) 154 and/or management device 160 using a network interface 130. Network interface 130 is a hardware network interface, such as a network interface card (NIC), etc. Network 128 may be an external network such as the Internet, or an internal network such as an Ethernet or a virtual private network (VPN).

Furthermore, in an embodiment in which the computers/devices are mobile devices, network 128 is a wireless network. Examples of such as wireless network include, but are not limited to, a near field communication (NFC) network (in which devices communicate at ranges of 4 cm or less); personal area networks (PANs), such as those that use industrial, scientific, and medical (ISM) radio bands and protocols defined in the Institute of Electrical and Electronics Engineers (IEEE) 802.15.1 standard for wireless communications within a few meters; and/or a Wi-Fi network, which enables wireless communication in a range of approximately 100 meters in accordance with the IEEE 802.11x standards.

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems such as authorized mobile receiving device 152, other users' mobile device(s) 154, and/or management device 160.

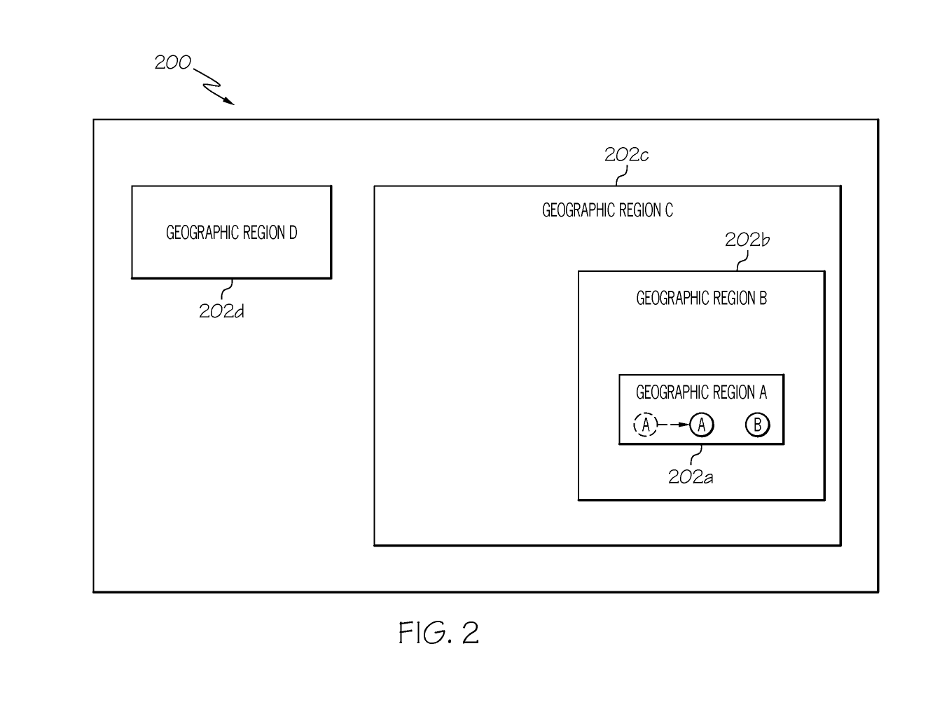

Application programs 144 in computer 102's system memory (as well as software deploying server 150's system memory) also include a geographic-based content sharing logic (GBCSL) 148. GBCSL 148 includes code for implementing the processes described below, including those described and/or referenced in FIGS. 2-4. In one embodiment, computer 102 is able to download GBCSL 148 from software deploying server 150, including in an on-demand basis, wherein the code in GBCSL 148 is not downloaded until needed for execution. Note further that, in one embodiment of the present invention, software deploying server 150 performs all of the functions associated with the present invention (including execution of GBCSL 148), thus freeing computer 102 from having to use its own internal computing resources to execute GBCSL 148.

Also within computer 102 is a position logic 156. Position logic 156 is hardware logic that is able to determine the physical location of computer 102 in real time. For example, position logic 156 may be a global positioning system (GPS) receiver, a local triangulation system (e.g., that receives wireless signals from local transmitters, and triangulates these signals to establish a fine-grained location of a device), or any other positioning system known to those skilled in the art for determining a current location of a device.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

As described herein, one embodiment of the present invention is directed to selectively sharing content between mobile devices based on 1) a geographic location of a mobile device that is receiving shared content, and/or 2) a predefined content and/or content category that may be shared with mobile devices within certain predetermined geographic areas (e.g., a room in a building, a building, a campus, a city block, a group of city blocks, a city, a state, etc.).

With reference now to FIG. 2, an exemplary geographic map 200 of various geographic regions 202a-202d (where “d” represents an integer) that have been defined by a user according to the respective regions' authorization to receive content from a user's mobile device is presented. For clarity purposes, geographic regions 202a-202d will now be referred to respectively as “region A-region D”.

Region A is a smallest of the depicted regions. An exemplary region A is a research laboratory (e.g., a single room or suite of rooms within a building). Region B contains region A as well as other geographic areas. An exemplary region B may be the building in which both the research laboratory (region A) and other offices are contained. An exemplary region C may be an entire enterprise campus, which includes the building that is region B as well as other buildings, parking lots, etc. Region D is outside of region C, and thus is not part of the enterprise campus that is encompassed by region C. Region D may be contiguous to region C, or (as depicted) region D may be non-contiguous to region C.

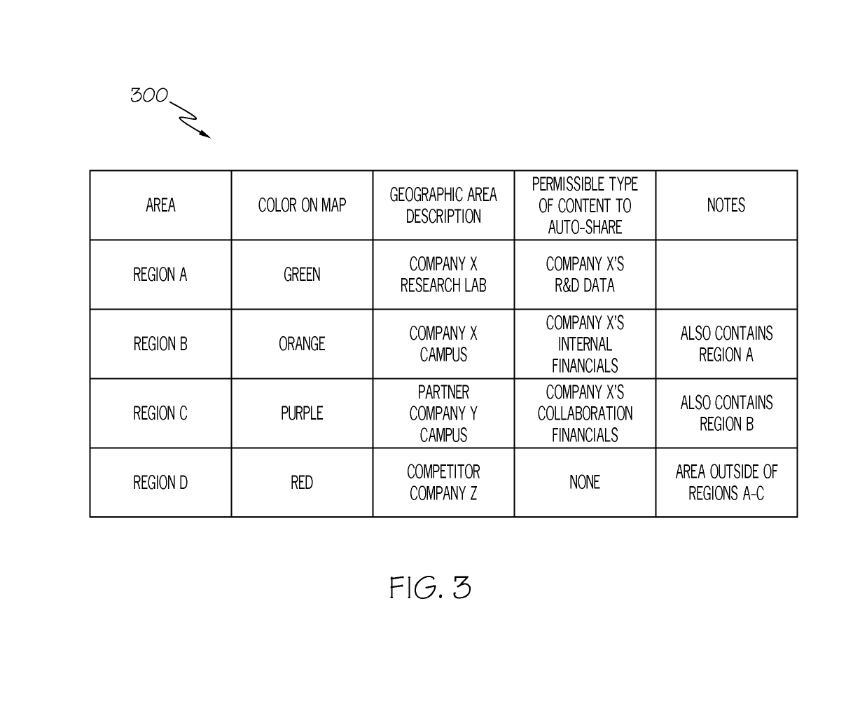

Each of the regions A-D shown in FIG. 2 have their own rules regarding what can and cannot be shared between mobile devices. For example, consider table 300 shown in FIG. 3, which illustrates an exemplary table of information describing the map in FIG. 2 and/or what type of content is authorized to be shared within and/or between each of the geographic regions shown in the map in FIG. 2.

For example, consider region A in table 300. As described, region A is color coded (i.e., shaded and/or bordered) with the color green. For exemplary purposes, assume that region A is a room or suite of rooms that contain a research and development (R&D) lab under the management/ownership of Company X. Assume now that a first mobile device (e.g., computer 102 shown in FIG. 1) contains R&D data about projects being worked on by Company X.

In one embodiment, the real-time physical locations of the first mobile device, the second mobile device, and other users' mobile device(s) (e.g., other users' mobile device(s) 154 shown in FIG. 1) are established by position logic, such as position logic 156 shown in FIG. 1. The position of the second and/or other users' mobile devices are then transmitted to the first mobile device, which determines whether the second and/or other users' mobile devices are within geographic regions in which certain content and/or content categories are permitted by GBCSL 148 in FIG. 1.

In one embodiment, the first mobile device is authorized to share R&D data with a second mobile device (e.g., authorized mobile receiving device 152 and/or other users' mobile device(s) 154 shown in FIG. 1) only if the second mobile device is physically within the R&D lab, but regardless of where the first mobile device is physically located.

In one embodiment, the first mobile device is authorized to share R&D data with a second mobile device only if the second mobile device is physically within the R&D lab, and only if the first mobile device is also physically within the R&D lab at the same time as the second mobile device.

In one embodiment, the second mobile device is able to permanently retain the R&D data that it received from the first mobile device. In another embodiment, however, when the second mobile device is moved from the R&D lab (region A), the shared R&D data from the first mobile device is automatically deleted from the second mobile device.

With further reference to FIG. 2 and FIG. 3, assume now that a second mobile device is within region B. As noted in graph 300 in FIG. 3, region B also encompasses region A. However, region B (which is color coded orange on the geographic map 200 in FIG. 2) describes areas outside of region A as well. Therefore, data that can be shared between the first mobile device and the second mobile device is more limited. For example, the first mobile device may be authorized to share information about Company X's internal financial information, but is not authorized to share Company X's R&D data. That is, if the second mobile device is known to be within region A, then it can receive Company X's R&D data. However, if it is only known that the second mobile device is somewhere on the campus of Company X (region B), without knowing exactly where on the campus (e.g., possibly in an area that is outside of region A), then the second mobile device is no longer permitted to receive Company X's R&D data from the first mobile device. However, the second mobile device is able to receive Company X's internal financial information while on Company X's campus (region B). Similarly, if it is known that the second mobile device is within region B but outside of region A, then the second mobile device is prohibited from receiving Company X's R&D data from the first mobile device.

Continuing with the example shown in FIG. 2 and FIG. 3, assume now that a second mobile device is within region C, but is either outside of region B, or is at an undetermined location within region C. Region C, which is color coded purple on the geographic map 200 in FIG. 2, is a multi-campus of partner enterprises. For example, assume that Company X and Company Y are partners on a particular project. As long as the second mobile device is anywhere with region C, it can receive data about Company X's financial information related to this partnership (but not financial information related to Company X alone).

Finally, if the second mobile device is within region D (color coded red on the geographic map 200 in FIG. 2), no data may be shared from the first mobile device, since the second mobile device is now on the campus of Company Z, which is a competitor of Company X.

In one embodiment, the authorized zones (i.e., user-defined permissible geographic areas for sharing data from a user's mobile device) are defined by a user tracing an area on a map. For example, assume that geographic map 200 depicted in FIG. 2 is being displayed on a user interface. The authorized zones are identified and/or delineated by a mouse/cursor, a stylus pen, and/or (in the case of the user interface being displayed on a touch screen) the movement of the user's finger around the authorized zones displayed on the touch screen. Thus, the user is able to trace a boundary on a map displayed on the user-interface, thereby allowing the user to define the permissible geographic areas for sharing data from a user's mobile device.

In one embodiment, the user is enabled not only to define the user-defined permissible geographic area for sharing data from the user's mobile device, but is also able to seamlessly identify what type of content can be shared by dragging and dropping a description of the digital content (that is authorized for sharing) onto the permitted geographic area (where this authorized data may be shared) displayed on the map. Thus, a monitoring/control device will receive a signal from the user's mobile device indicating the digital content being associated with the permitted geographic area displayed on the map, where the signal indicates that the user has dragged and dropped a description of the digital content onto the permitted geographic area displayed on the map.

As described herein, the first mobile device shares/sends content to an “authorized” mobile receiving device, referred to herein in various embodiments as a second mobile device. In one embodiment, the term “authorized” is defined as a device having been pre-determined to be authorized to receive data from the first mobile device, dependent on the real-time physical location of the mobile receiving device. That is, if the mobile receiving device 1) is within a certain predefined geographic region, and 2) has been previously “authorized” to receive certain content, then the first mobile device will share such content with the mobile receiving device. In order to be “authorized”, various methodologies may be used. For example, in one embodiment a certain user or person holding a certain title/role is associated with the mobile receiving device through a lookup table, security dongle (security flash drive), etc. If that person holds this title/role or has inserted the dongle into the mobile receiving device, then that mobile receiving device is deemed “authorized”.

In another embodiment, however, the “authorization” of the mobile receiving device is based solely on the mobile receiving device being within a certain geographic region (e.g., Regions A-D discussed above in FIGS. 2-3). That is, criteria used to categorize certain geographic regions are the sole basis for identifying a mobile receiving device (within such geographic regions) as being “authorized”.

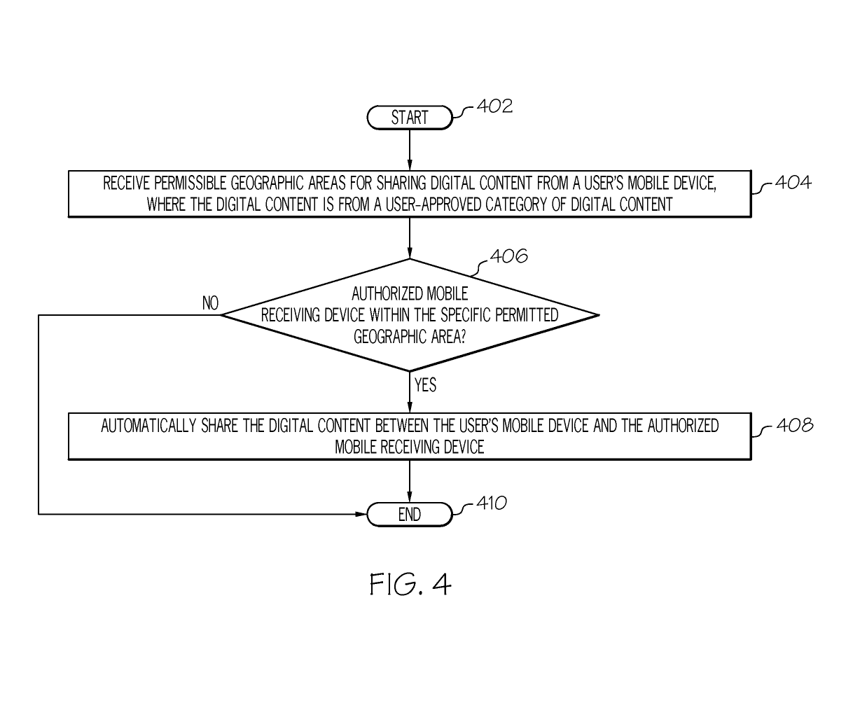

With reference now to FIG. 4, a high level flow chart of one or more exemplary steps taken by one or more processors to auto-share content between mobile devices based on their location and the type of content is presented. After initiator block 402, one or more processors, in a user's mobile device and/or an authorized mobile receiving device, receive user-defined permissible geographic areas for sharing data from the user's mobile device, as described in block 404. That is, permissible geographic areas for sharing digital content from a user's mobile device are received by the mobile device whose user will be sharing the digital content, which is from a user-approved category of digital content. The digital content may be streaming content, video files, text files, or other digital content capable of being transmitted from the user's mobile device to the authorized mobile receiving device. Criteria used to identify whether a particular user-defined permissible geographic region is within a permissible (i.e., authorized) area for receiving predetermined types of data from a user's mobile device include, but are not limited to the following:

Place of business: i.e., if a particular area is the home of a particular business, then an authorized mobile device within that area is allowed to receive certain predetermined content and/or content categories;

Street names: i.e., a geographic region defined as a city block between First St. and Second St. in a particular city;

Geographic coordinates: i.e., a specific point (i.e. latitude/longitude) and/or the area within a predefined radius of that specific point;

User-specified area via mapping tools: i.e., a user has previously drawn an area on a mapping tool.

In one embodiment, a management device (e.g., management device 160 and/or computer 102 depicted in FIG. 1) receives a definition of user-designated digital content from a user-approved content category that is authorized to be shared between the user's mobile device and an authorized mobile receiving device that is within a specific permitted geographic area, wherein the specific permitted geographic area is from the user-defined permissible geographic areas. For example, a user of the first mobile device (“user's mobile device”) enters in both content as well as content categories that can be shared with a second mobile device (“authorized mobile receiving device”), depending on where that second mobile device is located. While “content” is defined as specific playlists/libraries/files/folders/data or other specific content selected by the user of the first mobile device (e.g., by selecting such playlists/libraries/files/folders/data from a listing displayed on a user interface on the first mobile device) for sharing, “content categories” are descriptors of the type of content that the user has defined as being authorized (based on the location of the mobile device to which the content is being shared) for sharing.

Thus, a user of the first mobile device designates (from a listing, or by typing into a field on a user interface, etc.) content categories that can be shared. Examples of such content categories include, but are not limited to:

Work-related content: i.e., content that is related to work projects that a user of the first mobile device and the second mobile device are both working on;

User-defined source content: i.e., content that comes from a certain type of source, such as a personal folder, a social media website, a public marketing website, a folder of video-only files, etc.

As described in query block 406, a determination is made as to whether the authorized mobile receiving device is within the specific permitted geographic area. If not, the process ends at terminator block 410. However, if the authorized receiving device is within the specific permitted geographic area, then (assuming that any security protocols that may be in place are being followed) the first mobile device (“user's mobile device”) automatically shares the user-designated content (i.e., digital content that has been approved for sharing) with the second mobile device (“authorized mobile receiving device”), as described in block 408.

Note that in one embodiment, if a determination is made that the authorized mobile receiving device has subsequently moved outside the specific permitted geographic area, then sharing of the user-designated content between the user's mobile device and the authorized mobile receiving device is automatically blocked and/or deleted from the authorized mobile receiving device.

In various embodiments, the first mobile device and the second mobile device share content with one another until:

The first device (and/or the user of the first device) is directed to “stop sharing” with the second device;

A content owner, of content being shared from the first device, specifies that a maximum number of permitted sharing devices has been reached (e.g., according to terms of a licensing agreement); and/or

The second device has moved outside of the permissible ranges/areas.

In one embodiment, users of the second mobile device (e.g., the authorized mobile receiving device) are enabled to preview some portion of the primary user's content. That is, before the second mobile device actually receives the shared content from the first device, a preview of a portion of the shared content, or at least a description of the proposed shared content, is sent to the second mobile device. The user of the second mobile device is thus able to accept or reject the full version of the shared content.

In one embodiment, one or more processors (e.g., in the first mobile device—“user's mobile device”) transmit a description of the user-designated content to the authorized mobile receiving device. The first mobile device (“user's mobile device”) then receives an authorization from the second mobile device (“authorized mobile receiving device”) to transmit the user-designated content from the user's mobile device to the authorized mobile receiving device. In an alternative embodiment, this authorization comes from a device other than the second mobile device, such as one or more of the other users' mobile device(s) 154 depicted in FIG. 1, or from a third party monitoring device (e.g., management device 160 depicted in FIG. 1). Upon receiving this authorization, the first mobile device transmits the user-designated content to the second device. In one embodiment, all of the shared content is sent from the first mobile device to the second mobile device. In another embodiment, however, the user of the second mobile device marks which portions of the user-designated content are to be shared. The first mobile device then sends only the marked portions (selected by the user of the second mobile device) to the second mobile device.

In one embodiment, users of the second mobile device create playlists, append tags, rate content, etc. that the primary user (of the first mobile device) owns. That is, users of the second mobile device(s) not only can receive the content from the first mobile device, but can also manipulate this content into playlists, apply descriptive metatags to the shared content, rate/rank elements of the shared content, etc.

In one embodiment, content is shared between two devices only when such devices are within visual range of one another (i.e., the users of the two devices, and thus the two devices, are in visual range with one another). For example, assume that the two devices each have infrared (IR) light transceivers (e.g., IR transceiver 158 shown in FIG. 1), which can only communicate if there is an unobstructed line-of-sight between the two devices. If these two devices are unable to communicate (i.e., their IR transceivers cannot “see” one another), then content sharing ceases. That is, in one embodiment, one or more processors and line-of-sight transceivers in the user's mobile device and the authorized mobile receiving device determine whether the user's mobile device and the authorized mobile receiving device are in visual range of one another. In response to the line-of-sight transceivers determining that the user's mobile device and the authorized mobile receiving device are no longer in visual range of one another, one or more processors (in either the user's mobile device or the authorized mobile receiving device) block further sharing of the user-designated content between the user's mobile device and the authorized mobile receiving device.

In one embodiment, priority is granted to users walking toward (to meet) or away from (after meeting) the content owner. For example, consider content receiving device A and content sharing (i.e., transmitting) device B in FIG. 2. If computer logic (or alternatively the user of content sharing device B) detects that content receiving device A is moving towards content sharing device B (as depicted in FIG. 2), this movement will trigger the transmission of digital content from sharing device B to receiving device A. Similarly, in one embodiment, if computer logic (or alternatively the user of content sharing device B) detects that content receiving device A is moving away from content sharing device B (as depicted in FIG. 2), this movement will trigger the transmission of digital content from sharing device B to receiving device A.

In one embodiment, the authorized mobile receiving device is one of multiple authorized mobile receiving devices within the specific permitted geographic area, and other devices from the multiple authorized mobile receiving devices are currently stationary (i.e., are not moving). In this embodiment, one or more processors and position devices in the user's mobile device and the authorized mobile receiving device detect that the authorized mobile receiving device is physically moving toward the user's mobile device. In response to this detection, the user-designated content is transmitted from the user's mobile device to the authorized mobile receiving device before transmitting the user-designated content from the user's mobile device to the other devices from the multiple authorized mobile receiving devices that are currently stationary. Similarly, in another embodiment, in response to the position devices detecting that the authorized mobile receiving device is physically moving away from the user's mobile device, the user-designated content is transmitted from the user's mobile device to the authorized mobile receiving device before transmitting the user-designated content from the user's mobile device to the other devices from the multiple authorized mobile receiving devices that are currently stationary.

In one embodiment, priority for the content is revoked for someone close to the edge of the sharing boundary in favor of someone closer to the content owner (or heading in that direction). Similarly, a determination may be made that those farther away, yet still within the authorized area, may need the content sent to them first, since they cannot simply verbally be told (by the user of the first mobile device) about the content. That is, in one embodiment, the authorized mobile receiving device is one of multiple authorized mobile receiving devices within the specific permitted geographic area. One or more processors and position devices in the multiple authorized mobile receiving devices detect that the authorized mobile receiving device is physically closer to the user's mobile device than other authorized mobile receiving devices from the multiple authorized mobile receiving devices. In response to the position devices in the multiple authorized mobile receiving devices detecting that the authorized mobile receiving device is physically closer to the user's mobile device than the other authorized mobile receiving devices from the multiple authorized mobile receiving devices, one or more processors transmit the user-designated content from the user's mobile device to the authorized mobile receiving device before transmitting the user-designated content from the user's mobile device to the other devices from the multiple authorized mobile receiving devices that are farther away from the user's mobile device. Similarly, in another embodiment, in response to the position devices in the multiple authorized mobile receiving devices detecting that the authorized mobile receiving device is physically farther away from the user's mobile device than the other authorized mobile receiving devices from the multiple authorized mobile receiving devices, one or more processors transmit the user-designated content from the user's mobile device to the authorized mobile receiving device before transmitting the user-designated content from the user's mobile device to the other devices from the multiple authorized mobile receiving devices that are closer to the user's mobile device.

As presented herein in various embodiments, the disclosed method enables a primary user to share content with another user within a specified proximate range. When friends (e.g., users of mobile devices) are within range, a user can specify what types of items can be shared with friends. Nearby friends can create playlists, append tags, rate content, etc. that the primary user owns. This ability to share in this manner eliminates the step of the primary user having to send out documents, allows friends to preview content, and also allows for friends to mark content that they would like to pull into their collection. The use of known-technologies can be used to detect nearby friends in the area.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A method of automatically sharing content between mobile devices, the method comprising:
receiving permissible geographic areas for sharing digital content from a user's mobile device, wherein the digital content is from a user-approved category of digital content;
determining whether an authorized mobile receiving device is within a specific permitted geographic area from the permissible geographic areas; and
in response to determining that the authorized mobile receiving device is within the specific permitted geographic area, automatically sharing, by one or more processors, the digital content between the user's mobile device and the authorized mobile receiving device.

2. The method of claim 1, wherein the digital content is streaming content that is streamed from the user's mobile device to the authorized mobile receiving device.

3. The method of claim 1, further comprising:
receiving a permissible set of users who are authorized to receive the digital content;
determining whether any user from the permissible set of users is currently within the specific permitted geographic area; and
in response to determining that no user from the permissible set of users is currently within the specific permitted geographic area, blocking the sharing of the digital content between the user's mobile device and the authorized mobile receiving device.

4. The method of claim 1, further comprising:
in response to determining that the authorized mobile receiving device has moved outside the specific permitted geographic area, automatically blocking the sharing of the digital content between the user's mobile device and the authorized mobile receiving device.

5. The method of claim 1, further comprising:
determining whether the authorized mobile receiving device has left the specific permitted geographic area after receiving the digital content from the user's mobile device; and
in response to determining that the authorized mobile receiving device has left the specific permitted geographic area after receiving the digital content from the user's mobile device, sending a signal to the authorized mobile receiving device to delete the digital content from the authorized mobile receiving device.

6. The method of claim 1, further comprising:
determining whether the user's mobile device and the authorized mobile receiving device are both within the specific permitted geographic area at a same time; and
in response to determining that the user's mobile device and the authorized mobile receiving device are not both within the specific permitted geographic area at the same time, blocking the sharing of the digital content between the user's mobile device and the authorized mobile receiving device.

7. The method of claim 1, further comprising:
transmitting a description of the digital content to a management device;
receiving an authorization from the management device to transmit the digital content that matches the description from the user's mobile device to the authorized mobile receiving device; and
in response to receiving the authorization to transmit the digital content, transmitting the digital content from the user's mobile device to the authorized mobile receiving device.

8. The method of claim 1, further comprising:
transmitting a description of the digital content to a management device;
receiving an authorization from the management device to transmit only a portion of the digital content that matches the description from the user's mobile device to the authorized mobile receiving device; and
in response to receiving the authorization to transmit only the portion of the digital content, transmitting the portion of the digital content from the user's mobile device to the authorized mobile receiving device.

9. The method of claim 1, further comprising:
determining, by line-of-sight transceivers in the user's mobile device and the authorized mobile receiving device, whether the user's mobile device and the authorized mobile receiving device are within visual range of one another; and
in response to the line-of-sight transceivers determining that the user's mobile device and the authorized mobile receiving device are no longer within visual range of one another, transmitting a signal to the authorized mobile receiving device to delete the digital content, which has been received from the user's mobile device, from the authorized mobile receiving device.

10. The method of claim 1, further comprising:
detecting, by position devices in the user's mobile device and the authorized mobile receiving device, that the authorized mobile receiving device is physically moving toward the user's mobile device; and
in response to the position devices detecting that the authorized mobile receiving device is physically moving toward the user's mobile device, transmitting the digital content from the user's mobile device to the authorized mobile receiving device.

11. The method of claim 1, wherein the authorized mobile receiving device is one of multiple authorized mobile receiving devices that are currently within the specific permitted geographic area, wherein other authorized mobile receiving devices from the multiple authorized mobile receiving devices are currently stationary, and wherein the method further comprises:
detecting, by position devices in the user's mobile device and the authorized mobile receiving device, that the authorized mobile receiving device is physically moving toward the user's mobile device; and
in response to the position devices detecting that the authorized mobile receiving device is physically moving toward the user's mobile device, transmitting the digital content from the user's mobile device to the authorized mobile receiving device before transmitting the digital content from the user's mobile device to the other authorized mobile receiving devices that are currently stationary.

12. The method of claim 1, further comprising:
detecting, by position devices in the user's mobile device and the authorized mobile receiving device, that the authorized mobile receiving device is physically moving away from the user's mobile device; and
in response to the position devices detecting that the authorized mobile receiving device is physically moving away from the user's mobile device, transmitting the digital content from the user's mobile device to the authorized mobile receiving device.

13. The method of claim 1, wherein the authorized mobile receiving device is one of multiple authorized mobile receiving devices that are currently within the specific permitted geographic area, and wherein the method further comprises:
detecting, by position devices in the multiple authorized mobile receiving devices, that the authorized mobile receiving device is physically closer to the user's mobile device than other authorized mobile receiving devices from the multiple authorized mobile receiving devices; and
in response to the position devices in the multiple authorized mobile receiving devices detecting that the authorized mobile receiving device is physically closer to the user's mobile device than the other authorized mobile receiving devices, transmitting the digital content from the user's mobile device to the authorized mobile receiving device before transmitting the digital content from the user's mobile device to the other authorized mobile receiving devices that are farther away from the user's mobile device.

14. The method of claim 1, wherein the authorized mobile receiving device is one of multiple authorized mobile receiving devices that are currently within the specific permitted geographic area, and wherein the method further comprises:
detecting, by position devices in the multiple authorized mobile receiving devices, that the authorized mobile receiving device is physically farther away from the user's mobile device than other authorized mobile receiving devices from the multiple authorized mobile receiving devices; and
in response to the position devices in the multiple authorized mobile receiving devices detecting that the authorized mobile receiving device is physically farther away from the user's mobile device than the other authorized mobile receiving devices, transmitting the digital content from the user's mobile device to the authorized mobile receiving device before transmitting the digital content from the user's mobile device to the other authorized mobile receiving devices that are closer to the user's mobile device.

15. The method of claim 1, further comprising:
receiving an input that defines the specific permitted geographic area on a map that is displayed on a user interface, wherein the input is generated by a user tracing a boundary on a map displayed on the user-interface, and wherein tracing the boundary defines the specific permitted geographic area for sharing data from the user's mobile device.

16. The method of claim 15, further comprising:
displaying a real-time location of the authorized mobile receiving device on the map.

17. The method of claim 15, further comprising:
receiving a signal from the user's mobile device indicating the digital content being associated with the permitted geographic area displayed on the map, wherein the signal indicates that the user has dragged and dropped a description of the digital content onto the permitted geographic area displayed on the map.

18. A computer program product for automatically sharing content between mobile devices, the computer program product comprising a computer readable storage medium having program code embodied therewith, the program code readable and executable by one or more processors to perform a method comprising:
receiving user-defined permissible geographic areas for sharing data from a user's mobile device;
receiving a digital content and a user-approved content category that are authorized to be shared between the user's mobile device and an authorized mobile receiving device that is within a specific permitted geographic area, wherein the specific permitted geographic area is from the user-defined permissible geographic areas;
determining whether the authorized mobile receiving device is within the specific permitted geographic area; and
in response to determining that the authorized mobile receiving device is within the specific permitted geographic area, automatically sharing the digital content, from the user-approved content category, between the user's mobile device and the authorized mobile receiving device.

19. A computer system comprising:
a processor, a computer readable memory, and a computer readable storage medium;
first program instructions to receive user-defined permissible geographic areas for sharing data from a user's mobile device;
second program instructions to receive a digital content and a user-approved content category that are authorized to be shared between the user's mobile device and an authorized mobile receiving device that is within a specific permitted geographic area, wherein the specific permitted geographic area is from the user-defined permissible geographic areas;
third program instructions to determine that the authorized mobile receiving device is within the specific permitted geographic area; and
fourth program instructions to, in response to determining that the authorized mobile receiving device is within the specific permitted geographic area, automatically share the digital content, from the user-approved content category, between the user's mobile device and the authorized mobile receiving device; and wherein
the first, second, third, and fourth program instructions are stored on the computer readable storage medium for execution by the processor via the computer readable memory.

20. The computer system of claim 19, further comprising:
fifth program instructions to determine whether the user's mobile device and the authorized mobile receiving device are both within the specific permitted geographic area at a same time; and
sixth program instructions to, in response to determining that the user's mobile device and the authorized mobile receiving device are not both within the specific permitted geographic area at the same time, block the sharing of the digital content, from the user-approved content category, between the user's mobile device and the authorized mobile receiving device; and
wherein
the fifth and sixth program instructions are stored on the computer readable storage medium for execution by the processor via the computer readable memory.
